(19) United States
(12) Patent Application Publication
(10) Pub. No.: US 2013/0055072 A1
(43) Pub. Date: Feb. 28, 2013

(54) Multi-Threaded Graphical Display System

(71) Applicants: Robert Douglas Arnold, San Francisco, CA (US); Shaheen Ashok Gandhi, Seattle, WA (US)

(72) Inventors: Robert Douglas Arnold, San Francisco, CA (US); Shaheen Ashok Gandhi, Seattle, WA (US)

(21) Appl. No.: 13/216,830

(22) Filed: Aug. 24, 2011

(51) Int. Cl. G06F 17/00

(52) U.S. Cl. 715/240; 715/234

(57) ABSTRACT

In one embodiment, a computer program executed by a main processor of a computing device renders a web page in a graphical user interface by generating a plurality of render object data structures for the web page, generating a raster image for each of the plurality of render object data structures, and creating a separate thread configured to be executed by a graphics processor of the computing device to composite the raster images into one image to be displayed in the graphical user interface.

### TECHNICAL FIELD

The present disclosure generally relates to rendering a structured document in a graphical user interface, and, more particularly, to rendering a structured document with a plurality of threads utilizing both a main processor and a graphics processor of a computing device.

### BACKGROUND

A structured document such as a web page may include page content such as text and images, page layout information, and scripting codes. A layout engine is a software component containing code for rendering structured documents in a graphical user interface.

A graphics processor or graphics processing unit (GPU) is a specialized circuit for efficiently manipulating geometrical representation of computer graphics and generating images for output to a display of a computing device. A graphics processor may comprise one or more integrated circuits and/or processing cores that are directed to mathematical operations commonly used in graphics rendering. In some implementations, a graphics processor may use a special graphics unit instruction set, while in other implementations, a graphics processor may use a central processing unit or CPU-like (e.g., a modified x86) instruction set. A graphics processor can implement a number of graphics primitive operations, such as blitting, texture mapping, pixel shading, frame buffering, and the like. In additional to three-dimensional or 3D hardware, a graphics processor may include basic two-dimensional or 2D acceleration and frame buffer capabilities. In addition, a graphics processor may support YUV color space and hardware overlays, as well as MPEG (Motion Picture Experts Group) primitives (such as motion compensation and iDCT or inverse discrete cosine transform). A graphics processor may be a graphics accelerator, a general purpose GPU (GPGPU), or any other suitable processing unit. A graphics processor can be implemented as an individual chip in a computing device, or as part of a chip or multi-chip module containing a main processor of a computing device. An application hosted by a computing device can access a graphics processor by incorporating an application programming interface (API) to the graphics processor. Examples of graphics processor APIs are OpenGL (managed by Khronos Group) and Direct3D by Microsoft.

### SUMMARY

Particular embodiments relate to a multi-threaded rendering process that utilizes both a main processor and a graphics processor of a computing device. A multi-threaded rendering process executed by the main processor of the computing device may render a web page by generating a plurality of render object data structures for the web page, generating a raster image for each of the plurality of render object data structures, and creating a separate thread configured to be executed by the graphics processor of the computing system to composite the raster image into one image to be displayed in the computing device's display. These and other features, aspects, and advantages of the disclosure are described in more detail below in the detailed description and in conjunction with the following figures.

### BRIEF DESCRIPTION OF THE DRAWINGS

FIG. 1 illustrates an example method of rendering structured documents with a plurality of threads.

FIGS. 2A and 2B illustrate an example user interface of an address book application hosted by a mobile phone.

FIG. 3 illustrates an example computer system.

### DETAILED DESCRIPTION

The invention is now described in detail with reference to a few embodiments thereof as illustrated in the accompanying drawings. In the following description, numerous specific details are set forth in order to provide a thorough understanding of the present disclosure. It is apparent, however, to one skilled in the art, that the present disclosure may be practiced without some or all of these specific details. In other instances, well known process steps and/or structures have not been described in detail in order not to unnecessarily obscure the present disclosure. In addition, while the disclosure is described in conjunction with the particular embodiments, it should be understood that this description is not intended to limit the disclosure to the described embodiments. To the contrary, the description is intended to cover alternatives, modifications, and equivalents as may be included within the spirit and scope of the disclosure as defined by the appended claims.

A structured document such as a web page may include, for example, page layout information, scripts, page content such as text (e.g., ASCII or HTML), media data (e.g., graphics, photos, video clips), and executable code objects (e.g., a game executable within a browser window or frame). Structured documents may be implemented with languages and technologies such as Hypertext Markup Language (HTML), Extensible Markup Language (XML), Extensible Hypertext Markup Language (XHTML), JavaScript, WebGL, Cascading Style Sheet (CSS) including CSS animations and transitions, and, frequently, Java. A structured document may itself include references to multiple structured documents and contents. For example, a web page may include one or more inline references by incorporating Uniform Resource Locations (URLs) and/or script code (e.g., JavaScript, PHP, AJAX) that in response to a user event (e.g., a mouse click, a mouse hover-over), causes an application displaying the web page in a graphical user interface to dynamically retrieve content specified by an URL and the script code.

A layout engine (or web browser engine) is a software component or library for rendering structured documents in a graphical user interface. For example, Google's Chrome web browser and Apple's Safari web browser use WebKit software to render web pages. WebKit includes a layout engine WebCore and a JavaScript engine JavaScriptCore (for interpreting and executes JavaScript code). An application hosted by a computing device may utilize a layout engine to render structured documents by incorporating modules in the layout engine via an application programming interface (API) to the layout engine. A rendering process of an application incorporating a layout engine may access a structured document (e.g., a web page), and divide the structured document into one or more layers—e.g., based on HTML <div> or <iframe> tags. The rendering process may parse each layer into a render object data structure. For example, the rendering process may parse a layer of a structured document into a render object tree or a tree of nodes in Document Object Model (DOM) representation, wherein each node of a tree of nodes may comprise text, an image object, other DOM object, or a pointer or root of another tree of nodes. The rendering process may generate a raster image (i.e., a bitmap image) for each layer based on the render object tree and composite or combine raster images of the one or more layers into a single image to be displayed in a graphical user interface.

A rendering process of an application hosted by a computing device may comprise a single thread executed by a processor of the computing device. On the other hand, a rendering process of an application hosted by a computing device may utilize available processing resources of the computing device more efficiently by creating multiple threads, wherein each thread comprises a portion of instructions of the rendering process to be executed by at least one of the available processors of the computing device. For example, the rendering process may have two threads, a first thread executed by a first processor of the computing device and a second thread executed by a second processor of the computing device. The first thread may execute JavaScript code in a web page, interpret layout and style information of the web page, determine one or more layers of the web page, and create a render object tree for each layer of the one or more layers. The second thread may handle user input events, pass the user input events to the first thread, create raster images based on the render object trees, and composite the raster images into an image to be displayed in the computing device's display. Particular embodiments herein describe methods of rendering structured documents with a plurality of threads, wherein a thread of the plurality of threads may be executed by a main processor or a graphics processor of a computing device.

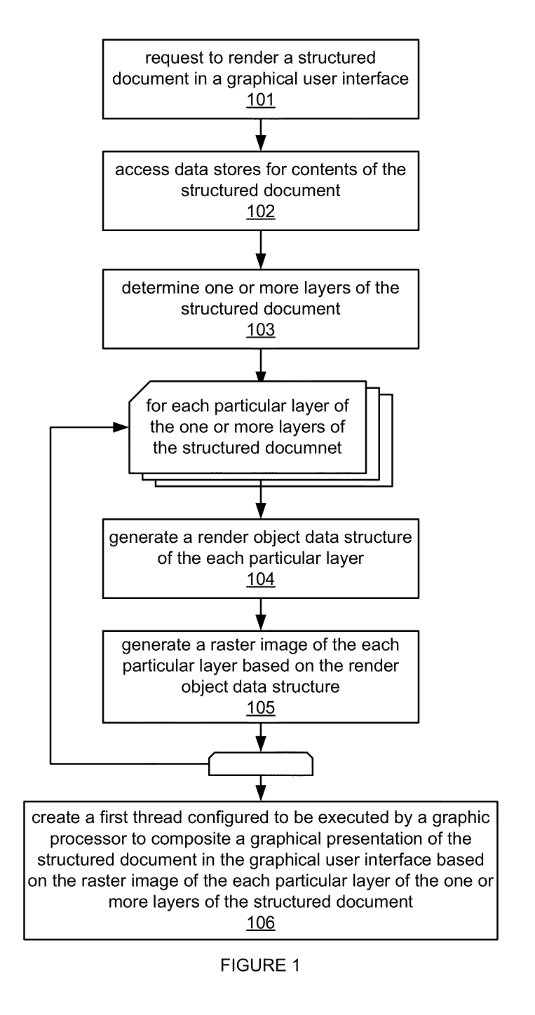

FIG. 1 illustrates an example method of rendering structured documents with a plurality of threads. In one implementation, the processes described herein can be implemented in connection with a browser client (or any other application) to display one or more web pages or other structured documents. In other implementations, the processes can be used by an operating system in connection with rendering a GUI-based shell, as well as other applications, such as a phone dialer, an address book, a calendar and the like. FIG. 1 can be implemented by a multi-threaded rendering process executed by one or more main processors of a computing device. In particular embodiments, the computing device (e.g., a desktop computer, a game console, a laptop computer, a tablet computer, a mobile phone, a smart phone, or other portable devices) may comprise one or more main processors and one or more graphics processors. In particular embodiments, the multi-threaded rendering process may receive a request to render a structured document in a graphical user interface (101). For example, a web browser application executed by one or more main processors of a computing device may, in response to a user input (e.g., a mouse click on an URL link), cause the multi-threaded rendering process to render a web page in the web browser's graphical user interface. In particular embodiments, the multi-threaded rendering process may access one or more data stores for one or more contents of the structured document (102). For example, the multi-threaded rendering process may access a web server of a web site and retrieve contents of a web page specified by an URL. For example, the multi-threaded rendering process may execute a scripting code (e.g., JavaScript code) embedded within a web page and retrieve content from a remote server or from a local data storage based on the execution of the scripting code. For example, the multi-threaded rendering process may access a remote server for a web page's layout information in CSS style sheets. In particular embodiments, the multi-threaded rendering process may determine one or more layers of the structured documents (103). For example, the multi-threaded rendering process can determine one or more layers based on HTML <div> or <iframe> tags in a web page.

In particular embodiments, for each particular layer of the one or more layers of the structured document, the multi-threaded rendering process may generate a render object data structure of the each particular layer (104). For example, the multi-threaded rendering process can generate a render object tree in DOM representation for each layer of a plurality of layers in a web page. In particular embodiments, for each particular layer of the one or more layers of the structured document, the multi-threaded rendering process may generate a raster image of the each particular layer based on the render object data structure (105). For example, the multi-threaded rendering process can generate a raster image (bitmap image) for each layer of a plurality of layers in a web page based on the render object tree of the each layer.

As graphics processors are efficient in compositing raster images, the multi-threaded rendering process may spin off a separate thread to one or more graphics processors of the computing device (e.g., via an API to the graphics processors), causing the one or more graphics processors to composite raster images of the layers of the web page into an image to be displayed in the graphical user interface. In particular embodiments, the multi-threaded rendering process may create a first thread configured to be executed by at least one of the one or more graphics processors to composite a graphical presentation of the structured document in the graphical user interface based on the raster image of each particular layer of the one or more layers of the structured document (106). Additionally, in particular embodiments, the multi-threaded rendering process may create a first thread configured to be executed by at least one of the one or more graphics processors to create animation for one or more contents of the structured document. For example, the multi-threaded rendering process may create a first thread configured to be executed by at least one of the one or more graphics processors to composite the raster images of the one or more layers of a web page into a sequence of images. For example, the sequence of images may create an animation effect of an overlaying frame entering a web browser window from the top of the browser window and hovering over in the middle of the browser window.

In addition to a separate thread for compositing raster images of the one or more layers of the structured document, the multi-threaded rendering process may create additional threads, wherein each thread is configured to generate a render object data structure (or a raster image) for each layer of the one or more layers of the structured document. As illustrated in the example of FIG. 1, in particular embodiments, for each particular layer of the one or more layers of the structured document, the multi-threaded rendering process may create a second thread configured to be executed by the one or more main processors to generate a render object data structure of the each particular layer (104). In particular embodiments, the multi-threaded rendering process may create a third thread configured to be executed by the one or more main processors to generate a raster image of the each particular layer based on the render object data structure (105). In one embodiment, the multi-threaded rendering process may create a third thread configured to be executed by at least one of the one or more graphics processors to generate a raster image of the each particular layer based on the render object data structure. An operating system kernel of the computing device may monitor workload for each of the one or more main processors and the one or more graphics processors, and dynamically schedule a thread to an available processor.

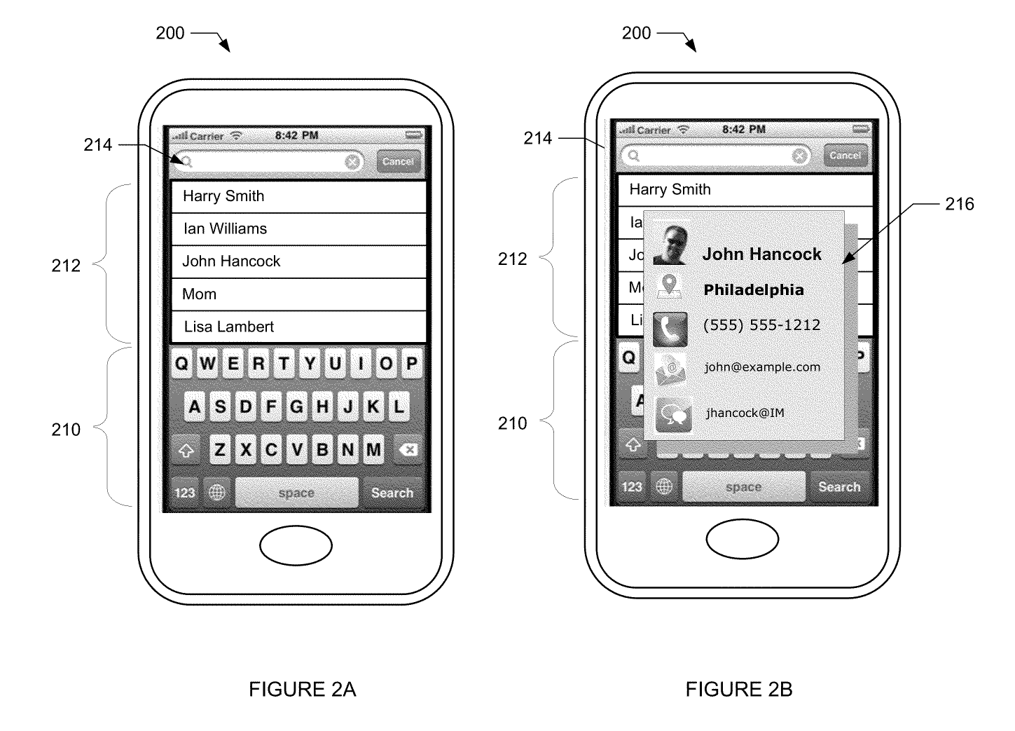

The example method of FIG. 1 can be further illustrated by an example user interface of FIGS. 2A and 2B. A user interface of an application hosted by a computing device may be implemented with structured documents. For example, an application's user interface may comprise any number of displays or frames. Each display or frame of the user interface may display structured documents. Thus a user may interact with the application through a series of displays (e.g., a series of web pages). For example, for a mobile device with Google's Android operating system, an application's user interface may comprise one or more View objects of Java class “android.view.View.” Each View object occupies a rectangular area on the mobile device's screen and is responsible for drawing and event handing. Each View object of the user interface may comprise one or more WebView objects of Java Class “android.webkit.WebView.” Each WebView object displays web pages and includes methods to navigate forward and backward through a history, zoom in and out, perform text searches and more. Thus the user interface may comprise any number of WebView objects, wherein the WebVeiw objects display web pages implementing the user interface.

FIGS. 2A and 2B illustrate an example user interface of an address book application hosted by a mobile phone. In the example of FIG. 2A, a user interface of an address book application hosted by mobile phone 200 may comprise structured documents displayed in a plurality of frames in the mobile phone's touch display. For example, a first frame may contain a structured document for a software keyboard (210), a second frame may contain a structured document for a list of contacts (212), and a third frame may contain a structured document for a search input field (214). For example, during the execution of the address book application, the address book application may cause a multi-threaded rendering process (as illustrated in the example of FIG. 1) executed by one or more main processors of mobile phone 200 to render the address book application's user interface. The multi-threaded rendering process may access a local storage of mobile phone 200 for contents, and layout and format information of each of the user interface. For each frame or layer, the multi-threaded rendering process may generate a render object tree and generate a raster image based on the render object tree. The multi-threaded rendering process then may create a separate thread configured to be executed by at least one of one or more graphics processors of mobile device 200 to composite the raster images into a single image to be displayed in the mobile phone's touch display, as illustrated in FIG. 2A.

For example, during execution of the address book application, a user may select a contact (“John Hancock”) in the list of contacts (in frame 212) by using a touch input. In response to the user's selection, the address book application may cause the multi-threaded rendering process to construct a frame 216 containing information of the selected contact. The multi-threaded rendering process may access a remote server for the selected contact's current location information (“Philadelphia”), and access a local storage of mobile phone 200 for the selected contact's communication channel information (e.g., a phone number, an email address, a user name for an instant messaging or IM service), and layout and format information for frame 216. U.S. patent application Ser. No. 12/976,791, filed on 22 Dec. 2010, which is herein incorporated by reference in its entirety and for all purposes, describes a method of constructing a frame containing user profile information including location data and communication channel information of a target user, and displaying the frame overlay on a graphical user interface. Since raster images already exist for frames 210, 212, and 214, the multi-threaded rendering process may generate a render object tree and generate a raster image based on the render object tree for frame 216 only. The multi-threaded rendering process then may create a separate thread configured to be executed by at least one of the one or more graphics processors of mobile phone 200 to composite the raster image of frame 216 overlaying the raster images for frames 210, 212, 214 into a single image to be displayed in the mobile phone's touch display, as illustrated in FIG. 2B. Alternatively, the multi-threaded rendering process may create a separate thread (a composite thread) configured to be executed by at least one of the one or more graphics processors of mobile phone 200 to composite the raster images of frame 210, 212, 214 and 216 into a sequence of images, wherein the sequence of images creates an animation effect of frame 216 entering the mobile phone's touch display from the right side of the touch display and hovering over the rest of frames 210, 212, and 214 in the middle of the touch display. By utilizing these multiple threads, particular embodiments enable the composite thread to create smooth animation (e.g., running animation at steady frame rates) without requiring cooperation of scripts or other executable codes in a structured document, and/or cooperation of other threads to yield control of the thread at particular time intervals.

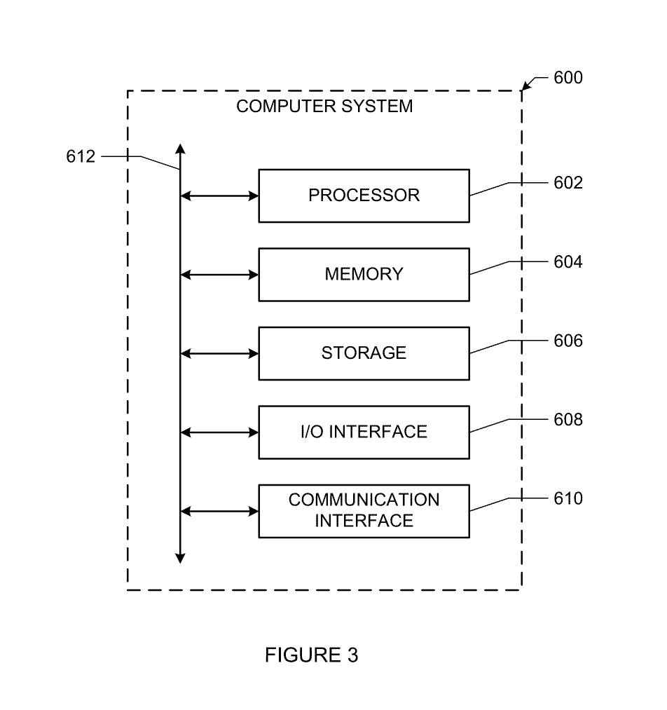

The rendering functionality described above can be implemented as a series of instructions stored on a computer-readable storage medium that, when executed, cause a programmable processor of a computing device to implement the operations described above. FIG. 3 illustrates an example computer system 600, which may be used with some embodiments of the present invention. This disclosure contemplates any suitable number of computer systems 600. This disclosure contemplates computer system 600 taking any suitable physical form, such as a desktop computer, laptop, notebook, or smartphone. As example and not by way of limitation, computer system 600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, computer system 600 may include one or more computer systems 600; be unitary or distributed; span multiple locations; span multiple machines; or reside in a cloud, which may include one or more cloud components in one or more networks. Where appropriate, one or more computer systems 600 may perform without substantial spatial or temporal limitation one or more steps of one or more methods described or illustrated herein. As an example and not by way of limitation, one or more computer systems 600 may perform in real time or in batch mode one or more steps of one or more methods described or illustrated herein. One or more computer systems 600 may perform at different times or at different locations one or more steps of one or more methods described or illustrated herein, where appropriate.

In particular embodiments, computer system 600 includes a processor 602, memory 604, storage 606, an input/output (I/O) interface 608, a communication interface 610, and a bus 612. In particular embodiments, processor 602 includes hardware for executing instructions, such as those making up a computer program. As an example and not by way of limitation, to execute instructions, processor 602 may retrieve (or fetch) the instructions from an internal register, an internal cache, memory 604, or storage 606; decode and execute them; and then write one or more results to an internal register, an internal cache, memory 604, or storage 606. In particular embodiments, processor 602 may include one or more internal caches for data, instructions, or addresses. In particular embodiments, memory 604 includes main memory for storing instructions for processor 602 to execute or data for processor 602 to operate on. As an example and not by way of limitation, computer system 600 may load instructions from storage 606 or another source (such as, for example, another computer system 600) to memory 604. Processor 602 may then load the instructions from memory 604 to an internal register or internal cache. To execute the instructions, processor 602 may retrieve the instructions from the internal register or internal cache and decode them. During or after execution of the instructions, processor 602 may write one or more results (which may be intermediate or final results) to the internal register or internal cache. Processor 602 may then write one or more of those results to memory 604. One or more memory buses (which may each include an address bus and a data bus) may couple processor 602 to memory 604. Bus 612 may include one or more memory buses, as described below. In particular embodiments, one or more memory management units (MMUs) reside between processor 602 and memory 604 and facilitate accesses to memory 604 requested by processor 602. In particular embodiments, memory 604 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM.

In particular embodiments, storage 606 includes mass storage for data or instructions. As an example and not by way of limitation, storage 606 may include an HDD, a floppy disk drive, flash memory, an optical disc, a magneto-optical disc, magnetic tape, or a Universal Serial Bus (USB) drive or a combination of two or more of these. Storage 606 may include removable or non-removable (or fixed) media, where appropriate. Storage 606 may be internal or external to computer system 600, where appropriate. In particular embodiments, storage 606 is non-volatile, solid-state memory. In particular embodiments, storage 606 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these.

In particular embodiments, I/O interface 608 includes hardware, software, or both providing one or more interfaces for communication between computer system 600 and one or more I/O devices. Computer system 600 may include one or more of these I/O devices, where appropriate. One or more of these I/O devices may enable communication between a person and computer system 600. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 608 for them. Where appropriate, I/O interface 608 may include one or more device or software drivers enabling processor 602 to drive one or more of these I/O devices. I/O interface 608 may include one or more I/O interfaces 608, where appropriate. Although this disclosure describes and illustrates a particular I/O interface, this disclosure contemplates any suitable I/O interface.

In particular embodiments, communication interface 610 includes hardware, software, or both providing one or more interfaces for communication (such as, for example, packet-based communication) between computer system 600 and one or more other computer systems 600 or one or more networks. As an example and not by way of limitation, communication interface 610 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 610 for it. As an example and not by way of limitation, computer system 600 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 may communicate with a wireless PAN (WPAN) (such as, for example, a BLUETOOTH WPAN), a WI-FI network (such as, for example, a 802.11a/b/g/n WI-FI network, a 802.11s mesh network), a WI-MAX network, a cellular telephone network (such as, for example, a Global System for Mobile Communications (GSM) network, an Enhanced Data Rates for GSM Evolution (EDGE) network, a Universal Mobile Telecommunications System (UMTS) network, a Long Term Evolution (LTE) network), or other suitable wireless network or a combination of two or more of these.

In particular embodiments, bus 612 includes hardware, software, or both coupling components of computer system 600 to each other. As an example and not by way of limitation, bus 612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, a Universal Asynchronous Receiver/Transmitter (UART) interface, a Inter-Integrated Circuit (I²C) bus, a Serial Peripheral Interface (SPI) bus, a Secure Degital (SD) memory interface, a MultiMediaCard (MMC) memory interface, a Memory Stick (MS) memory interface, a Secure Digital Input Output (SDIO) interface, a Multi-channel Buffered Serial Port (McBSP) bus, a Universal Serial Bus (USB) bus, a General Purpose Memory Controller (GPMC) bus, a SDRAM Controller (SDRC) bus, a General Purpose Input/Output (GPIO) bus, a Separate Video (S-Video) bus, a Display Serial Interface (DSI) bus, a Advanced Microcontroller Bus Architecture (AMBA) bus, or another suitable bus or a combination of two or more of these. Bus 612 may include one or more buses 612, where appropriate.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

What is claimed is:

1. An apparatus comprising:
a memory;
one or more main processors;
one or more graphics processors;
a program comprising computer-readable instructions operative, when executed, to cause the one or more processors to:
in response to a request to render a structured document in a graphical user interface of an application executed by the one or more main processors:
access one or more data stores for one or more contents of the structured document;
determine one or more layers of the structured document;
for each particular layer of the one or more layers of the structured document:
generate a render object data structure of the each particular layer; and
generate a raster image of the each particular layer based on the render object data structure; and
create a first thread configured to be executed by at least one of the one or more graphics processors to composite a graphical presentation of the structured document in the graphical user interface based on the raster image of each particular layer of the one or more layers of the structured document.

2. The apparatus of claim 1, wherein to generate a render object data structure of the each particular layer, the program further comprises instructions operative to cause the one or more processors to:
create a second thread configured to be executed by the one or more main processors to generate a render object data structure of the each particular layer.

3. The apparatus of claim 1, wherein to generate a raster image of the each particular layer based on the render object data structure, the program further comprises instructions operative to cause the one or more processors to:
create a third thread configured to be executed by the one or more main processors to generate a raster image of the each particular layer based on the render object data structure.

4. The apparatus of claim 1, wherein to generate a raster image of the each particular layer based on the render object data structure, the program further comprises instructions operative to cause the one or more processors to:
create a third thread configured to be executed by at least one of the one or more graphics processors to generate a raster image of the each particular layer based on the render object data structure.

5. The apparatus of claim 1, wherein the render object data structure comprises a tree data structure of nodes.

6. The apparatus of claim 1, wherein a layer of the one or more layers of the structured document comprises an inline frame.

7. The apparatus of claim 1, wherein the first thread is further configured to be executed by at least one of the one or more graphics processors to create animation for one or more contents of the structured document.

8. A method comprising:
in response to a request to render a structured document in a graphical user interface of an application hosted by a computing device, the computing device comprising one or more main processors and one or more graphics processors:
accessing one or more data stores for one or more contents of the structured document;
determining one or more layers of the structured document;
for each particular layer of the one or more layers of the structured document:
generating a render object data structure of the each particular layer; and
generating a raster image of the each particular layer based on the render object data structure; and
creating a first thread configured to be executed by at least one of the one or more graphics processors to composite a graphical presentation of the structured document in the graphical user interface based on the raster image of each particular layer of the one or more layers of the structured document.

9. The method of claim 8, wherein the generating a render object data structure of the each particular layer, further comprises:
creating a second thread configured to be executed by the one or more main processors to generate a render object data structure of the each particular layer.

10. The method of claim 8, wherein the generating a raster image of the each particular layer based on the render object data structure, further comprises:
creating a third thread configured to be executed by the one or more main processors to generate a raster image of the each particular layer based on the render object data structure.

11. The method of claim 8, wherein the generating a raster image of the each particular layer based on the render object data structure, further comprises:
creating a third thread configured to be executed by at least one of the one or more graphics processors to generate a raster image of the each particular layer based on the render object data structure.

12. The method of claim 8, wherein the render object data structure comprises a tree data structure of nodes.

13. The method of claim 8, wherein a layer of the one or more layers of the structured document comprises an inline frame.

14. The method of claim 8, wherein the first thread is further configured to be executed by at least one of the one or more graphics processors to create animation for one or more contents of the structured document.

15. One or more computer-readable tangible storage media embodying software operable when executed by a computing device to:
in response to a request to render a structured document in a graphical user interface of an application hosted by the computing device, the computing device comprising one or more main processors and one or more graphics processors:
access one or more data stores for one or more contents of the structured document;
determine one or more layers of the structured document;
for each particular layer of the one or more layers of the structured document:
generate a render object data structure of the each particular layer; and
generate a raster image of the each particular layer based on the render object data structure; and
create a first thread configured to be executed by at least one of the one or more graphics processors to composite a graphical presentation of the structured document in the graphical user interface based on the raster image of each particular layer of the one or more layers of the structured document.

16. The media of claim 15, wherein to generate a render object data structure of the each particular layer, further comprising software operable when executed by the computing device to:
create a second thread configured to be executed by the one or more main processors to generate a render object data structure of the each particular layer.

17. The media of claim 15, wherein to generate a raster image of the each particular layer based on the render object data structure, further comprising software operable when executed by the computing device to:
create a third thread configured to be executed by the one or more main processors to generate a raster image of the each particular layer based on the render object data structure.

18. The media of claim 15, wherein to generate a raster image of the each particular layer based on the render object data structure, further comprising software operable when executed by the computing device to:
create a third thread configured to be executed by at least one of the one or more graphics processors to generate a raster image of the each particular layer based on the render object data structure.

19. The media of claim 15, wherein the render object data structure comprises a tree data structure of nodes.

20. The media of claim 15, wherein a layer of the one or more layers of the structured document comprises an inline frame.

21. The media of claim 15, wherein the first thread is further configured to be executed by at least one of the one or more graphics processors to create animation for one or more contents of the structured document.
